(19) United States
(12) Patent Application Publication
(10) Pub. No.: US 2026/0319573 A1
(43) Pub. Date: Oct. 15, 2026

(54) CONTROLLER, INFORMATION PROCESSING DEVICE, AND INFORMATION PROCESSING METHOD

(71) Applicant: SONY GROUP CORPORATION, TOKYO (JP)

(72) Inventors: IKUO YAMANO, TOKYO (JP); TSUYOSHI ISHIKAWA, TOKYO (JP); SHIN SHIROMA, TOKYO (JP); HIROSHI YUASA, TOKYO (JP); KEIJIROH ISHWAR NAGANO, TOKYO (JP)

(21) Appl. No.: 19/481,917

(22) PCT Filed: Apr. 22, 2024
(86) PCT No.: PCT/JP2024/015698

§ 371 Date: Nov. 6, 2025

(30) Foreign Application Priority Data
May 15, 2023 (JP) 2023-080073

(51) Int. Cl. G06F 3/01; G06F 3/0346; G06F 3/0354

(52) U.S. Cl. CPC G06F 3/011; G06F 3/0346; G06F 3/03543

(57) ABSTRACT

A controller of the present disclosure includes a mouse function section configured to output coordinate information of a plane; a 6DoF function section configured to output position posture information; and a switching signal output section configured to output a switching signal for switching between a display mode of a two-dimensional image to which the coordinate information output from the mouse function section is applied and a display mode of a three-dimensional image to which the position posture information output from the 6DoF function section is applied.

### TECHNICAL FIELD

The present disclosure relates to a controller, an information processing device, and an information processing method.

### BACKGROUND ART

A system that performs a design review of computer-aided design (CAD) data, and the like, using a virtual reality (VR) head-mounted display (HMD) is becoming increasingly common.

Design tasks and review tasks are often performed separately, with a mouse typically used for design tasks and a 6DoF (six degrees of freedom) controller commonly used for review purposes.

### CITATION LIST

### Patent Literature

PTL 1: JP 2019-532396 A

### SUMMARY OF INVENTION

### Technical Problem

Known VR 6DoF controllers are designed for aerial operation and are therefore suitable for manipulating stereoscopically displayed three-dimensional (3D) objects in the air. However, they are not suitable for naturally performing precise tasks on a desk in terms of accuracy and ease of grip. On the other hand, a mouse, which is a generally adopted and favorable means for performing precise tasks on a desk, does not have the capability for aerial operation. Thus, in order to perform both types of operations using suitable means, it has been necessary for users to switch between a mouse and a VR controller, thus imposing a burden on the users.

In the related art, there has been disclosed a technique for providing a more natural user input mode by converting inputs from a plurality of 6DoF controllers into a common coordinate system. However, a controller has been disclosed that allows both three-dimensional tasks and tasks on a two-dimensional (2D) plane (display) to be performed.

In view of the above-mentioned problems, an object of the present disclosure is to provide a controller that can reduce burden on users by eliminating necessity of switching between a controller that performs three-dimensional tasks and a mouse that performs tasks on a two-dimensional plane, and an information processing device and an information processing method for processing signals from the controller.

### Solution to Problem

A controller of the present disclosure includes: a mouse function section configured to output coordinate information of a plane; a 6DoF function section configured to output position posture information; and a switching signal output section configured to output a switching signal for switching between a display mode of a two-dimensional image to which the coordinate information output from the mouse function section is applied and a display mode of a three-dimensional image to which the position posture information output from the 6DoF function section is applied.

An information processing device of the present disclosure includes a reception section configured to receive a switching signal for switching display modes of a two-dimensional image and a three-dimensional image; and a display mode switching section configured to switch a first display mode of displaying the two-dimensional image to a second display mode of displaying the three-dimensional image, in response to the received switching signal.

An information processing method of the present disclosure includes receiving a switching signal for switching display modes of a two-dimensional image and a three-dimensional image; and switching a first display mode of displaying the two-dimensional image to a second display mode of displaying the three-dimensional image, in response to the received switching signal.

### BRIEF DESCRIPTION OF DRAWINGS

FIG. 1 is a diagram for describing images of a 2D display and a 3D display in a design of a VR HMD according to an embodiment.

FIG. 2 is a diagram illustrating an action of moving a 3D display object and changing the posture thereof, using a controller according to the embodiment.

FIG. 3 is a diagram illustrating an action of designating a point on a three-dimensional space of a 3D display object, using the controller according to the embodiment.

FIG. 4 is a diagram illustrating an action of pointing (Ray control) of a 3D display object (not illustrated), using the controller according to the embodiment.

FIG. 5 is a rear view of the controller according to the embodiment.

FIG. 6 is a side view of the controller according to the embodiment.

FIG. 7 is a diagram illustrating a usage state where the controller according to the embodiment is used as a typical mouse.

FIG. 8 is a diagram illustrating an appearance of a controller equipped with a magnetic tracking mechanism according to the embodiment.

FIG. 9 is a diagram illustrating an appearance of a controller equipped with a luminous point tracking mechanism according to the embodiment.

FIG. 10 is a diagram for describing switching between a 2D operation and a 6DoF operation of the controller equipped with the luminous point tracking mechanism according to the embodiment, and the like.

FIG. 11 is a diagram for describing fingers used for operating the controller according to the embodiment.

FIG. 12 is a diagram illustrating a rear surface of the controller according to the embodiment when the controller is gripped as in a typical mouse operation.

FIG. 13 is a diagram illustrating a side surface of a controller 6 according to the embodiment when the controller is gripped as in a typical mouse operation.

FIG. 14 is a diagram illustrating a case where a 6DoF operation is performed with the controller according to the embodiment when the controller is gripped as in a typical mouse operation.

FIG. 15 is a front view of the controller according to the embodiment.

FIG. 16 is a diagram illustrating a position of a gravity center of the controller according to the embodiment.

FIG. 17 is a diagram for describing a structure of the controller according to the embodiment.

FIG. 18 is a diagram for describing a behavior of the controller according to the embodiment due to gravity when the controller is lifted.

FIG. 19 is a diagram for describing a relationship between an inner portion and an upper portion when the controller according to the embodiment is lifted.

FIG. 20 is a diagram illustrating a case where a front end of the controller is directed downward for a 3D operation.

FIG. 21 is a diagram for describing a relationship between an inner portion and an upper portion when the front end of the controller according to the embodiment is directed downward.

FIG. 22 is a diagram illustrating a case where the front end of the controller is directed upward for the 3D operation.

FIG. 23 is a diagram for describing a relationship with the inner portion when the front end of the controller according to the embodiment is directed upward.

FIG. 24 is a diagram illustrating a relationship between a distance from a plane measured with a distance sensor of the controller according to the embodiment and an operation.

FIG. 25 is a diagram illustrating a first switching example of an operation screen according to the embodiment.

FIG. 26 is a diagram illustrating a second switching example of an operation screen according to the embodiment.

FIG. 27 is a diagram illustrating a first example of switching of the button operation of the controller according to the embodiment between a case of a 2D operation (typical mouse operation) and a case of a 6DoF operation (aerial operation).

FIG. 28 is a diagram illustrating a second example of switching of the button operation of the controller according to the embodiment between a case of a 2D operation (typical mouse operation) and a case of a 6DoF operation (aerial operation).

FIG. 29 is a diagram illustrating a first pattern where a display screen is set to be a real monitor when the controller according to the embodiment is “2D-operated”.

FIG. 30 is a diagram illustrating a second pattern where the display screen is set to be a virtual screen when the controller according to the embodiment is “2D-operated”.

FIG. 31 is a diagram illustrating a third pattern where the display screen is set to be a virtual screen and a 3D display object when the controller according to the embodiment is “2D-operated”.

FIG. 32 is a diagram illustrating a fourth pattern where the display screen is set to be a virtual screen and a 3D display object or a 3D display object when the controller according to the embodiment is “6DoF-operated”.

FIG. 33 is a diagram illustrating a connection relationship between an HMD and the controller according to the embodiment.

FIG. 34 is a diagram illustrating a state where the controller according to the embodiment is connected to the HMD through a PC.

FIG. 35 is a functional block diagram of the controller according to the embodiment.

FIG. 36 is a flowchart for describing an action of a mouse function section and a 6DoF function section in response to a switching signal of the controller according to the embodiment.

FIG. 37 is a flowchart for describing an action of the mouse function section and the 6DoF function section in response to a switching signal of the controller 6 according to the embodiment.

FIG. 38 is a flowchart for describing a first example of an action in response to a switching signal of the HMD according to the embodiment.

FIG. 39 is a flowchart for describing a second example of an action in response to a switching signal of the HMD according to the embodiment.

FIG. 40 is a flowchart for describing a third example of an action in response to a switching signal of the HMD according to the embodiment.

FIG. 41 is a flowchart for describing a fourth example of an action for a flip-down operation of the HMD according to the embodiment.

FIG. 42 is a diagram illustrating a state where a controller with a pen-type mouse shape according to a variation of the shape of the controller according to the embodiment is in contact with a surface.

FIG. 43 is a diagram illustrating a state where the controller with the pen-type mouse shape according the variation of the shape of the controller according to the embodiment is lifted.

FIG. 44 is a diagram illustrating a configuration of the controller according to the variation of the embodiment.

FIG. 45 is a diagram illustrating a state where a controller with a grip-type mouse shape according to a variation of the shape of the controller according to the embodiment is in contact with a surface.

FIG. 46 is a diagram illustrating a state where the controller with the grip-type mouse shape according to the variation of the shape of the controller according to the embodiment is lifted.

FIG. 47 is a diagram illustrating a configuration of the controller according to the variation of the embodiment.

FIG. 48 is a diagram illustrating a state where a controller with a luminous point tracking mouse shape according to a variation of the shape of the controller according to the embodiment is in contact with a surface.

FIG. 49 is a diagram illustrating a state where the controller with the luminous point tracking mouse shape according to the variation of the embodiment is lifted.

FIG. 50 is a diagram illustrating a state where the controller with the luminous point tracking mouse shape according to the variation of the shape of the controller according to the embodiment is in contact with a surface.

FIG. 51 is a diagram illustrating a state where the controller with the luminous point tracking mouse shape according to the variation of the shape of the controller according to the embodiment is covered with a hand in a different manner.

FIG. 52 is a hardware configuration diagram illustrating an example of a computer that implements an information processing device of the HMD according to the embodiment.

### DESCRIPTION OF EMBODIMENTS

Hereinafter, a preferred embodiment of the present disclosure will be described in detail with reference to the accompanying drawings. In the present specification and drawings, components having substantially the same functional configuration are denoted by the same reference numerals, and redundant description thereof is omitted. The description will be given in the following order.
1. Coexistence image of 2D display and 3D display displayed on VR HMD
2. Definition of mouse
3. Main 6DoF operations
4. Means for 6DoF detection
5. Implementation example of controller 6 where mouse structure and 6DoF detection mechanism are integrated
6. Structure requirement for controller 6 according to embodiment
   6-1. First feature of controller 6 according to embodiment
   6-2. Second feature of controller 6
   6-3. Third feature of controller 6
   6-4. Fourth feature of controller 6
   6-5. Fifth feature of controller 6
7. Switching between 2D display/3 D display according to embodiment
8. Functional block diagram
   8-1. Connection configuration of controller 6 and HMD 5
   8-2. Functional block diagram of controller 6 according to embodiment
   8-3. Functional block diagram of HMD 5 according to embodiment
9. Description of actions
   9-1. Action of controller 6 according to embodiment
   9-2. Action of HMD 5 according to embodiment
      9-2-1. First action of HMD 5 according to embodiment
      9-2-2. Second action of HMD 5 according to embodiment
      9-2-3. Third action of HMD 5 according to embodiment
      9-2-4. Action for flip-down operation of HMD 5 according to embodiment
10. Variation of embodiment
   10-1. Shape of controller 6
      10-1-1. Pen-type mouse
         10-1-1-1. Third feature of controller 306 according to embodiment
      10-1-2. Grip-type mouse
         10-1-2-1. Third feature of controller 406 according to embodiment
   10-2. Shape of controller 6 (of case of luminous point tracking method)
   10-3. Example of switching of 2D operation/6 DoF operation with another controller structure
11. Hardware configuration

### 1. Coexistence Image of 2D Display and 3D Display Displayed on VR HMD

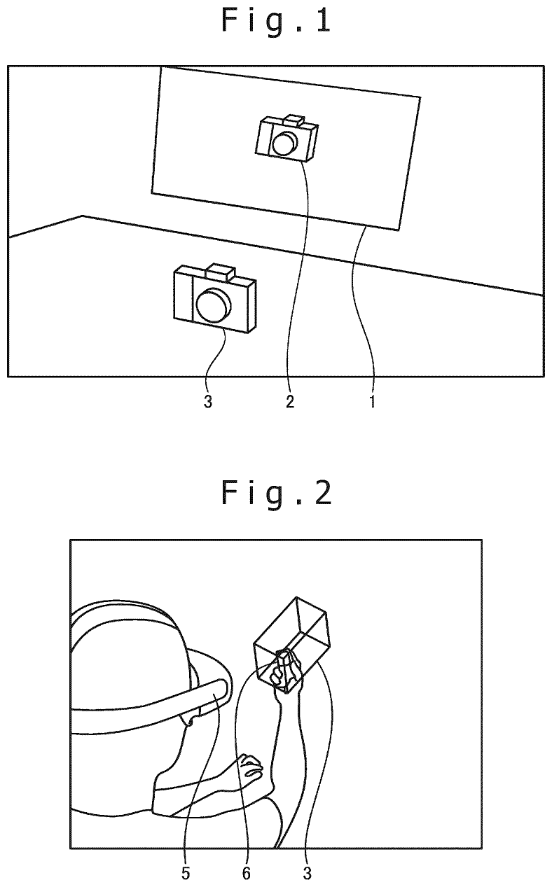

FIG. 1 is a diagram for describing images of a 2D display and a 3D display in a design of a VR HMD according to an embodiment. FIG. 1 illustrates an example where in a VR HMD, a virtual screen 1 (virtual monitor) and an object 3 of the 3D display, which is a camera to be reviewed, are displayed.

In the virtual screen 1, an object 2 of the 2D display of a camera to be designed is displayed. FIG. 1 illustrates an example where the object 3 of the 3D display is displayed on the front side of the object 2 of the 2D display.

For the object 2 of the 2D display, a mouse operation is favorable in view of its high position detection accuracy and ease of maintaining position. For the object 3 of the 3D display, a 6DoF operation is favorable in view of its intuitive operation and ease of spatial indication.

Note that, in the embodiment, the user may view a real monitor when the VR HMD is flipped up, instead of the virtual screen 1.

### 2. Definition of Mouse

In the embodiment, the mouse is a controller having the following configuration, and a typical mouse operation is referred to as “2D operation”.

### 2-1. Formed so as to be Operated on Plane Such as Desk

### 2-2. Including Sensor That Detects Two-Dimensional Relative Movement With Respect to Plane

### 2-3. Formed so as to Maintain its Position on Plane Even With No Operation

### 2-4. Including Operation Button

### 3. Main 6DoF Operations

Next, main 6DoF operations are described. The main 6DoF operations include movement of the object 3 of the 3D display, posture change (such as direct grabbing and releasing), designation of a point in a three-dimensional space (such as 3D modeling and wiring work), and pointing at a spatially arranged target (control of a ray (light beam)).

FIG. 2 is a diagram illustrating an action of moving the object 3 of the 3D display and changing the posture thereof, using the controller 6 of the embodiment. In FIG. 2, the user wearing an HMD 5 performs an action of “grabbing and releasing” the object 3 of the 3D display with a button (not illustrated) of the controller 6 as a trigger.

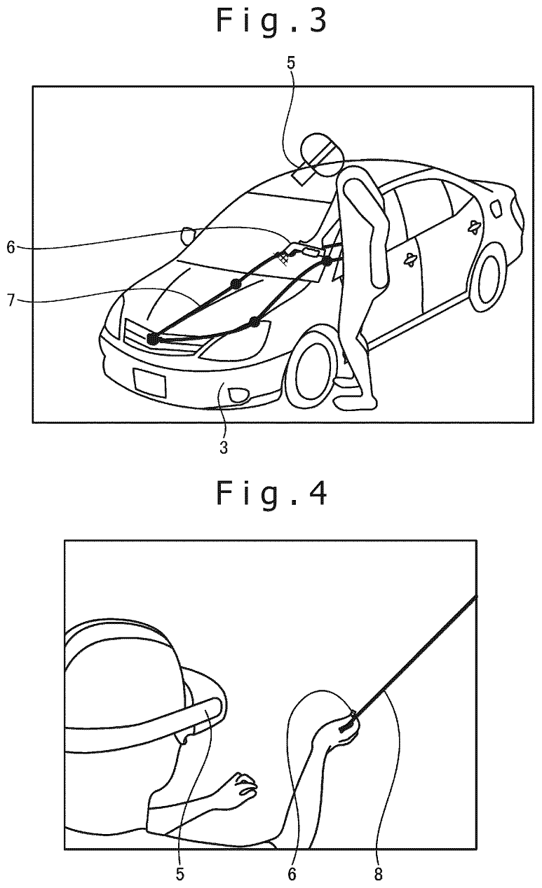

FIG. 3 is a diagram illustrating an action of designating a point in a three-dimensional space of the object 3 of the 3D display, which is a car, using the controller 6 of the embodiment. FIG. 3 illustrates an example where the user wearing the HMD 5 performs an action of “line drawing” to draw a line 7 on the object 3 of the 3D display with a button (not illustrated) of the controller 6 as a trigger for the line drawing.

FIG. 4 is a diagram illustrating an action of pointing (Ray control) of the object 3 of the 3D display (not illustrated) using the controller 6 of the embodiment. In FIG. 4, the user wearing the HMD 5 performs an action using a button (not illustrated) as a trigger for “grabbing and releasing” the object 3 of the 3D display indicated by a ray 8.

### 4. Means for 6DoF Detection

Examples of the means for 6DoF detection include a luminous point marker method, a laser-light reception method, a simultaneous localization and mapping (SLAM) camera method, a magnetic tracking method, and an ultrasound tracking method.

Examples of the luminous point marker method include an Oculus Touch controller and the like, examples of the laser-light reception method include a Vive controller and the like, examples of the magnetic tracking method include a Magic Leap One and the like, and examples of the ultrasound tracking method include a Magic Leap One and the like.

### 5. Implementation Example of Controller 6 Where Mouse Structure and 6DoF Detection Mechanism are Integrated

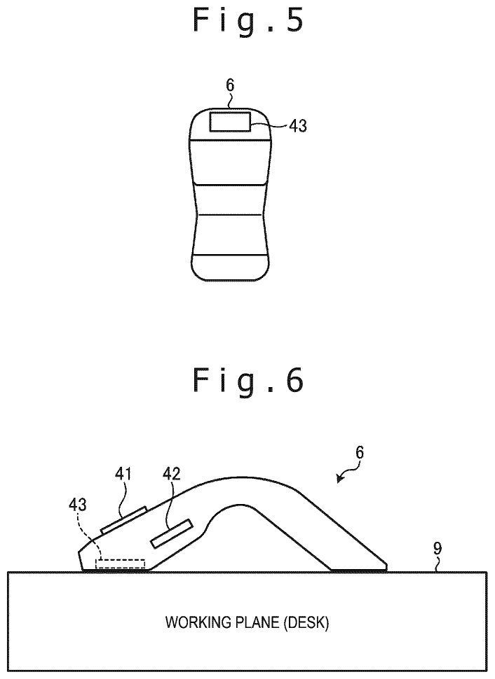

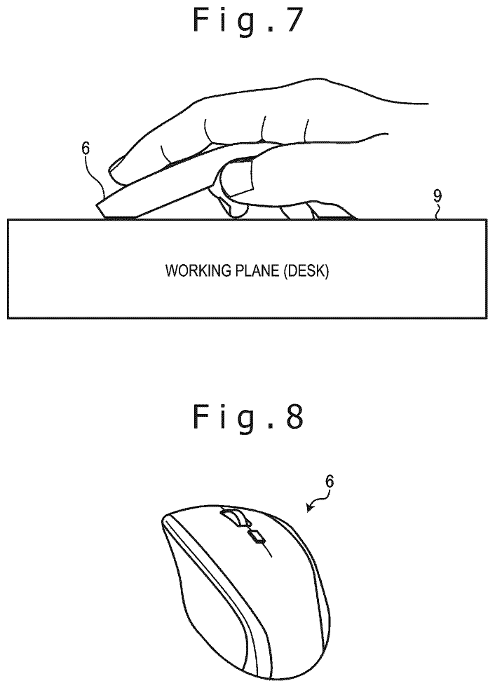

The controller 6 according to the embodiment in which a mouse structure and a 6DoF detection mechanism are integrated has a substantially chevron shape with its side surfaces bent upward. FIG. 5 is a rear view of the controller 6 according to the embodiment, and FIG. 6 is a side view of the controller 6 according to the embodiment. FIG. 7 is a diagram illustrating a usage state where the controller 6 according to the embodiment is used as a typical mouse.

An operation button is provided in the upper portion of the controller 6. In the case where the controller 6 is operated with the right hand, a left button 41 for operation with the index finger and a right button (not illustrated) for operation with the middle finger are provided in the upper portion of the controller 6 as illustrated in FIG. 6. In addition, a thumb button 42 for operation with the thumb is provided on the left side surface of the controller 6. Note that, in FIG. 7, the left button 41 and the thumb button 42 are omitted.

As illustrated in FIG. 6, the portions of the upper portion and lower portion of the controller 6 that make contact with a plane 9 are formed parallel to the plane 9.

Note that, in the interior of the controller 6, a movement detecting section 43 such as an optical sensor that outputs movement information with respect to the plane 9 is provided, and a mouse function section 62 (not illustrated) that outputs coordinate information on the plane 9 on the basis of the movement information output from the movement detecting section is provided.

The controller 6 satisfies the requirement for the mouse described in “2. Definition of mouse”. The portions of the upper portion and lower portion of the controller 6 that make contact with the plane 9 are formed parallel to the plane and the left button 41 and the right button are provided in the upper portion of the controller 6, for the operation on the plane 9. Accordingly, the requirement “2-1. Formed so as to be operated on plane such as desk” is satisfied.

The controller 6 includes the movement detecting section 43 such as an optical sensor. Accordingly, the requirement “2-2. Including sensor that detects two-dimensional relative movement with respect to plane” is satisfied.

The portions of the upper portion and lower portion of the controller 6 that make contact with the plane 9 are formed parallel to the horizontal direction. Accordingly, the requirement “2-3. Formed so as to maintain its position on plane even with no operation” is satisfied.

The left button 41 and right button are provided in the upper portion of the controller 6, and the thumb button 42 is provided on the left side surface of the controller 6. Accordingly, the requirement “2-4. Including operation button” is satisfied.

In addition, the appearance of the controller 6 may be that of a mouse-type controller 106 incorporating a magnetic tracking mechanism, which is externally similar to a known mouse, as illustrated in FIG. 8.

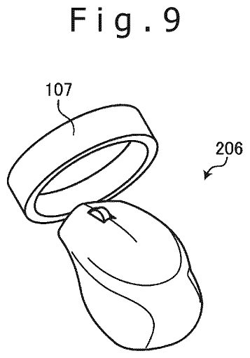

FIG. 9 is a diagram illustrating an appearance of a controller 206 equipped with a luminous point tracking mechanism according to the embodiment. The appearance of the controller 6 may be that of the controller 206 equipped with the luminous point tracking mechanism as illustrated in FIG. 9. As illustrated in FIG. 9, a ring 107 with a circular structure for disposing luminous points is provided at the front end of the controller 206.

### 6. Structure Requirement for Controller 6 According to Embodiment

Next, a structure requirement for the switching between a 2D operation and a 6DoF operation (3d operation) of the controller 6 according to the embodiment is described.

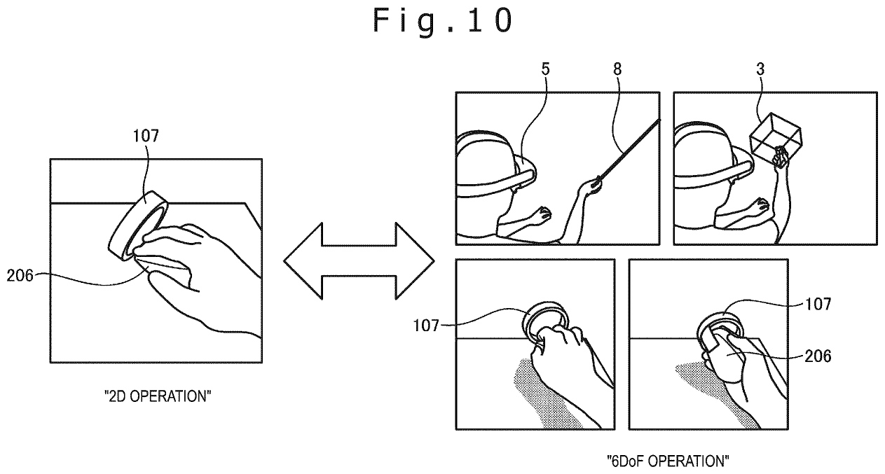

The controller 6 of the embodiment allows free and low-load switching between the “2D operation” of handling a mouse on a plane and the “6DoF operation” with the controller 6 lifted in the air. FIG. 10 is a diagram for describing switching between the 2D operation and the 6DoF operation of the controller 206 equipped with the luminous point tracking mechanism according to the embodiment, and the like.

As illustrated in FIG. 10, the 2D operation is enabled when the controller 206 is placed on a plane, and the 6DoF operation is enabled when the controller 106 is lifted from the plane. A structure that allows low-load lifting of the controller 206 will be described later.

Note that operations may be switched, recognizing another plane such as a wall, a leg (around the knee), or the palm of the left hand placed underneath as a “plane”, other than the horizontal plane such as a desk.

### 6-1. First Feature of Controller 6

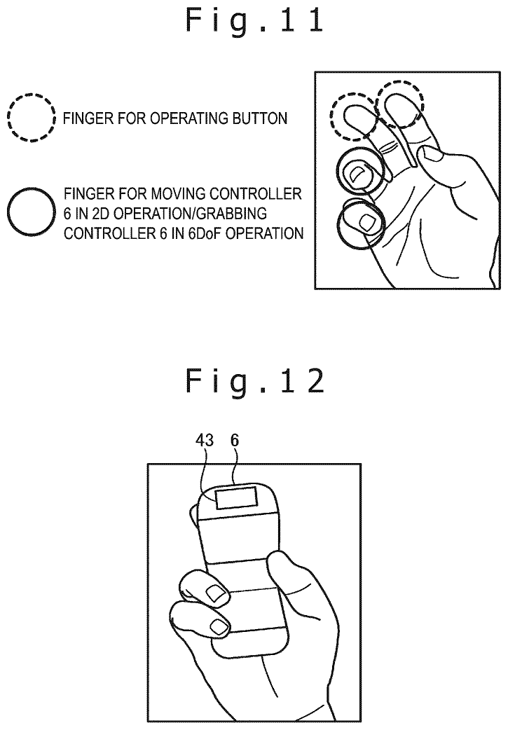

FIG. 11 is a diagram for describing fingers used for operating the controller 6 according to the embodiment. When the fingers are used as illustrated in FIG. 12, the thumb, ring finger, and little finger of the right hand move the controller 6 in the 2D operation, and grab the controller 6 in the 6DoF operation. The index finger and middle finger of the right hand are fingers that operate the operation button of the controller 6.

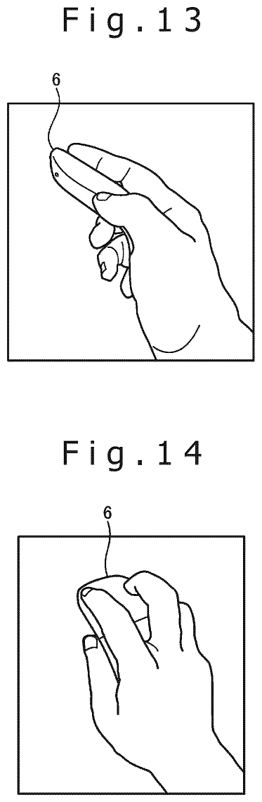

FIG. 12 is a diagram illustrating a rear surface of the controller 6 according to the embodiment when the controller 6 is gripped as in a typical mouse operation. FIG. 13 is a diagram illustrating a side surface of the controller 6 according to the embodiment when the controller 6 is gripped as in a typical mouse operation. FIG. 14 is a diagram illustrating a case where a 6DoF operation is performed with the controller 6 according to the embodiment when the controller 6 is gripped as in a typical mouse operation.

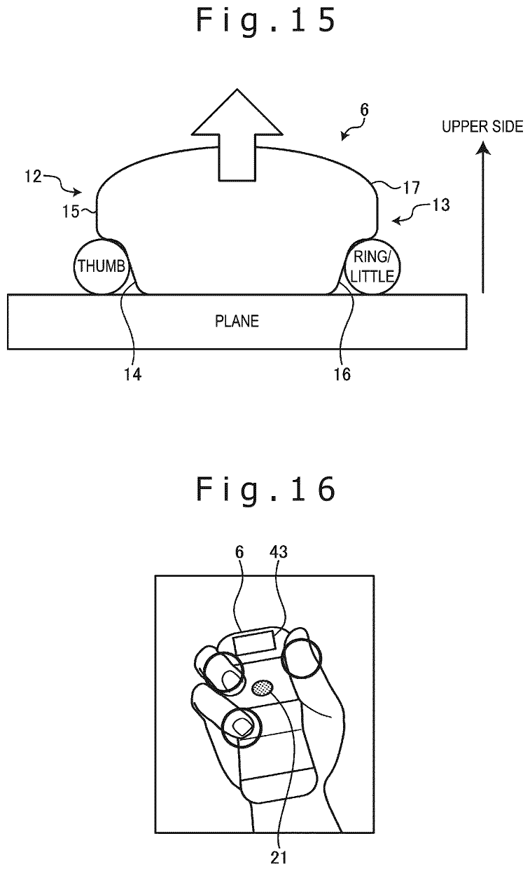

FIG. 15 is a front view of the controller 6 according to the embodiment. As illustrated in FIG. 15, the controller 6 according to the embodiment has a shape protruding outward on the upper side of the thumb and the ring finger/little finger of the operator when the controller 6 is mouse-operated (2D-operated) in a typical manner.

According to the embodiment, in which the controller 6 has such a shape, when the controller 6 is lifted, the controller 6 can be naturally lifted with low load without applying force of the fingers in the direction of grabbing the controller 6.

Specifically, the controller 6 has a first side surface 12 and a second side surface 13 on the opposite side of the first side surface 12, and the first side surface 12 includes a third side surface 14 and a fourth side surface 15 that is formed continuous with the third side surface 14 on the upper side of the third side surface 14 and on the outer side of the third side surface 14 in the controller 6 in front view of the controller 6.

The second side surface 13 includes a fifth side surface 16 and a sixth side surface 17 that is formed continuous with the fifth side surface 16 on the upper side of the fifth side surface 16 and on the outer side of the fifth side surface 16 in the controller 6 in front view of the controller 6.

### 6-2. Second Feature of Controller 6

For the second feature of the controller 6 according to the embodiment, when the controller 6 is mouse-operated (2D-operated) in a typical manner, a gravity center 21 of the controller 6 is located inside a triangle connecting the contact portions of the thumb and the ring finger/little finger of the operator with the controller 6. FIG. 16 is a diagram illustrating the position of the gravity center 21 of the controller 6 according to the embodiment.

As illustrated in FIG. 16, the gravity center 21 is located at the upper portion of the controller 6 with a substantially chevron shape and between the first side surface 12 and the second side surface 13. Specifically, the gravity center 21 is located between the fourth side surface 15 of the first side surface 12 and the sixth side surface 17 of the second side surface 13.

Positioning the gravity center 21 of the controller 6 in the above-described manner allows, when the controller 6 is lifted, the controller 6 to be naturally lifted with low load with the controller 6 not inclined, without applying force of the fingers in the direction of grabbing the controller 6.

### 6-3. Third Feature of Controller 6

The controller 6 according to the embodiment has a structure for preventing the movement of the controller 6 in the longitudinal direction in the palm due to the influence of gravity when the 6DoF operation is performed with the controller 6.

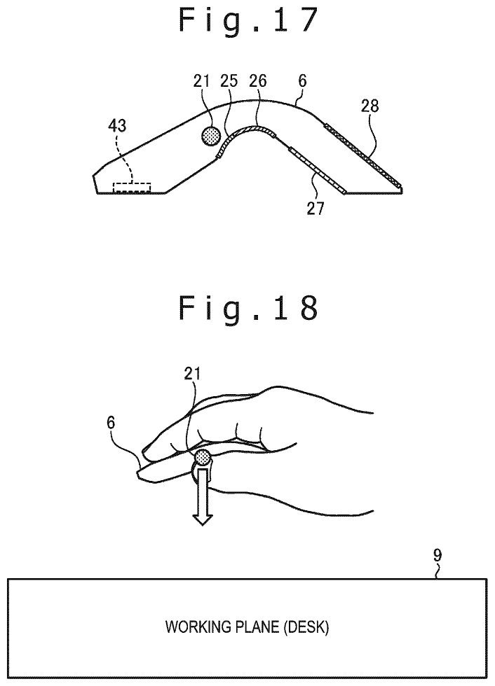

FIG. 17 is a diagram for describing a structure of the controller 6 according to the embodiment. As illustrated in FIG. 17, the controller 6 has a substantially chevron shape. The gravity center 21 of the controller 6 is located at a center portion in the interior of the controller 6. The controller 6 includes an inner portion 25 near the gravity center 21, an inner portion 26 adjacent to the inner portion 25 and at a center portion, an inner portion 27 at a lower side portion of the controller 6, and an upper portion 28 at a lower side portion of the controller 6. The prevention of the movement of the controller 6 using the inner portion 25, the inner portion 26, the inner portion 27, and the upper portion 28 is described below.

As illustrated in FIG. 5, the controller 6 is grabbed to perform a mouse operation. FIG. 18 is a diagram for describing a behavior of the controller 6 due to gravity when the controller 6 according to the embodiment is lifted. As illustrated in FIG. 18, when the controller 6 is lifted to perform a 3D operation, the controller 6 is likely to fall due to gravity.

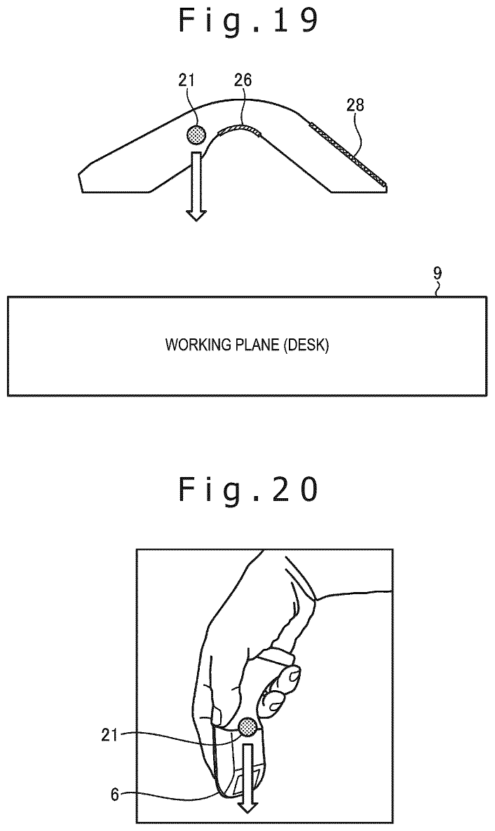

FIG. 19 is a diagram for describing a relationship between the inner portion 26 and the upper portion 28 when the controller 6 according to the embodiment is lifted. As illustrated in FIG. 19, when the controller 6 according to the embodiment is lifted for the 3D operation, a reactive force against the controller 6 that is likely to fall due to gravity is generated by the inner portion 26 mainly touching the side surface of the thumb, thereby preventing the fall. In addition, the contact between the palm and the upper portion 28 prevents the turn of the controller 6 that is likely to turn due to the gravity acting on the gravity center 21, whereby the posture of the controller 6 relative to the hand is maintained without the need to increase the gripping force or change the posture of the hand.

FIG. 20 is a diagram illustrating a case where the front end of the controller 6 is directed downward for the 3D operation. As illustrated in FIG. 20, when the front end of the controller 6 is directed downward, the controller 6 is likely to fall due to gravity.

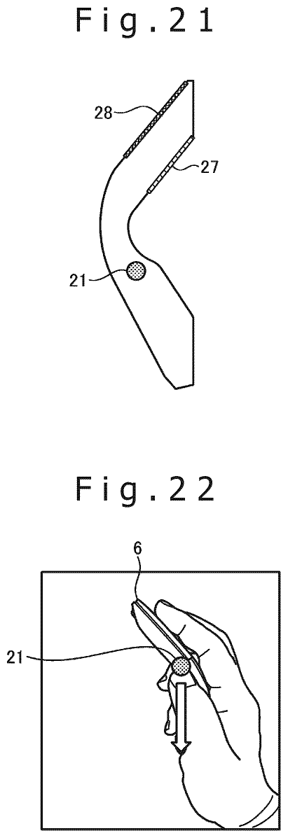

FIG. 21 is a diagram for describing a relationship between the inner portion 27 and the upper portion 28 when the front end of the controller 6 according to the embodiment is directed downward. As illustrated in FIG. 21, for the controller 6 according to the embodiment, when mouse selection is directed downward in a 3D operation, a reactive force against the mouse that is likely to fall due to gravity is generated by the inner portion 27 mainly touching the ring finger and little finger, thereby preventing the fall. In addition, the contact between the palm and the upper portion 28 prevents the turn, whereby the posture of the controller 6 relative to the hand is maintained without the need to increase the gripping force or change the posture of the hand.

FIG. 22 is a diagram illustrating a case where the front end of the controller 6 is directed upward for the 3D operation. As illustrated in FIG. 22, when the front end of the controller 6 is directed upward, the controller 6 is likely to fall due to gravity.

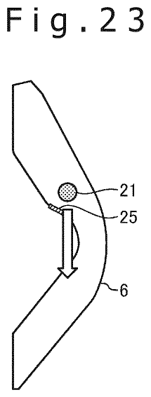

FIG. 23 is a diagram for describing a relationship with the inner portion 25 when the front end of the controller 6 according to the embodiment is directed upward. As illustrated in FIG. 23, when the controller 6 according to the embodiment is directed downward in the 3D operation, a reactive force against the controller 6 that is likely to fall due to gravity is generated by the inner portion 25 mainly touching the thumb, thereby preventing the fall. In addition, since the inner portion 25 is located on the lower side of the gravity center 21, the turning moment is not generated. In this manner, the posture of the controller 6 relative to the hand is maintained without the need to increase the gripping force or change the posture of the hand.

With such a structure, it is possible to maintain the position of the controller 6 within the palm without the need for the user to apply a gripping force to the controller 6.

### 6-4. Fourth Feature of Controller 6

The controller 6 according to the embodiment has a function of determining whether it is in a 2D operation or a 6DoF operation with an incorporated distance sensor 31, and outputting a switching signal for switching between a display mode of a two-dimensional image to which the coordinate information output from the mouse function section 62 is applied and a display mode of a three-dimensional image to which the position posture information output from a 6DoF function section 63 is applied.

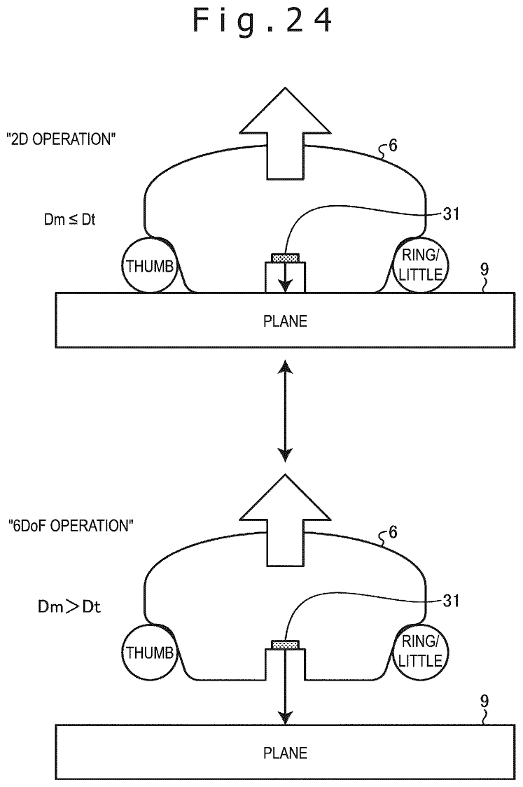

FIG. 24 is a diagram illustrating a relationship between a distance from a plane measured with the distance sensor 31 of the controller 6 according to the embodiment and an operation. As illustrated in FIG. 24, the controller 6 is 6DoF-operated when a distance Dm from the plane 9 measured with the distance sensor 31 is greater than a distance threshold value Dt (Dm>Dt), and is 2D-operated when the distance Dm is equal to or less than the distance threshold value Dt (Dm≤Dt). The controller 6 outputs the switching signal when switching from the 2D operation to the 6DoF operation.

The distance threshold value Dt is set to a value greater than the distance Dm generated by a lifting action in a typical mouse operation of the controller 6.

The controller 6 may output the switching signal for switching the operation screen by determining that the controller 6 is not horizontal by means of an inertial measurement unit (IMU).

A pressure sensor may be disposed on a side surface of the controller 6, and the switching signal may be output when detecting a lifting action from a change in lateral pressure that increases during the lifting.

Alternatively, from the location information of the 6DoF controller 6 and the location information of the working plane obtained with a camera mounted in the HMD 5 and the like, whether the controller 6 is located on the working plane may be determined, and the switching signal may be output.

Alternatively, in the case where the movement detecting section 43 (in FIG. 17, for example) for outputting movement information with respect to a plane is of an optical sensor type, the switching signal may be output, determining the operation, that is, whether the controller 6 is located on the working plane from the output information of the optical sensor.

While an example where the controller 6 outputs a switching signal is described above, the location information obtained from the controller 6 may be received on the main body (the PC 52, the HMD 5, and the like) side, the distance between the controller 6 and the plane on which the controller 6 is placed may be calculated from the received location information of the controller 6, and the switching processing may be performed on the main body side when the calculated distance is greater than a threshold distance.

In addition, the camera on the main body side acquires the light emission position of an infrared light-emitting diode (LED) of the controller 6, and the main body calculates the location information of the controller 6 from the light emission position of the controller 6 acquired from the camera. Then, the distance between the controller 6 and the plane on which the controller 6 is placed may be calculated from the location information of the controller 6 calculated by the main body, and the switching processing may be performed on the main body side when the calculated distance is greater than a threshold distance.

The 2D operation on a XY plane may be enabled even in the air n seconds after the controller 6 is held in the air in a normal posture (a posture parallel to the plane 9). At this time, a virtual plane is presented in a 3D virtual space. During an operation on the virtual plane, haptic feedback is presented to inform the user that the operation is being performed on a plane.

At the moment when the controller 6 lands or is lifted, the position in the 6DoF operation/2 D operation becomes unstable and the operability decreases, and therefore, the function of the 6DoF operation/2 D operation may be turned off in that period.

When the operation is returned from the 6DoF operation to the 2D operation, the initial position of the controller 6 is often lost, and therefore, the line of sight may be detected and the mouse cursor may be displayed at the position of the line of sight on the HMD 5. Alternatively, when the operation is returned to the 2D operation, the mouse cursor may be emphasized and displayed on the HMD 5 by being enlarged, for example.

The controller 6 itself does not need to have the above-mentioned switching detection function. The hand operating the controller 6 may be detected by hand tracking with the HMD 5 and the like, and the above-mentioned function switching may be performed depending on the position of the hand.

The state of whether the operation is in a 2D operation mode or a 6DoF operation mode may be presented by LED display and the like of the controller 6 or the HMD 5.

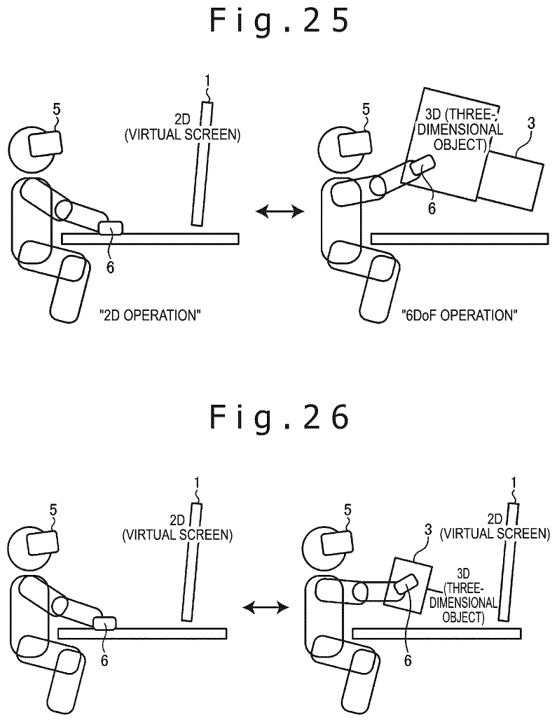

FIG. 25 is a diagram illustrating a first switching example of an operation screen according to the embodiment. As illustrated in FIG. 25, in the first switching example, the virtual screen 1 is displayed during the 2D operation, and only the object 3 of the 3D display is displayed during the 6DoF operation. That is, in the first switching example, the 3D display is turned on only in a 6DoF operation mode.

FIG. 26 is a diagram illustrating a second switching example of an operation screen according to the embodiment. As illustrated in FIG. 26, in the second switching example, the virtual screen 1 is displayed during the 2D operation, and the virtual screen 1 and the object 3 of the 3D display are displayed during the 6DoF operation. The object 3 of the 3D display is displayed in front of the virtual screen 1.

While the method of switching the display method in accordance with the state of the controller 6 is described above, an implementation is also conceivable in which a method of reflecting the operation of the controller 6 on a system is switched without switching the display method. For example, the following implementation is conceivable.

Both during the 2D operation and during the 6DoF operation, both the 2D virtual screen and the three-dimensional (3D) object are displayed in the display state as illustrated in the right diagram of FIG. 26. For such a state, during the 2D operation, the movement operation and button operation of the controller 6 are reflected as operations on the 2D virtual screen (for example, the mouse cursor is moved by the movement operation of the controller, and the determination operation for the cursor is performed by the button operation of the controller).

On the other hand, during the 6DoF operation, the movement operation and button operation of the controller 6 are reflected as operations on a three-dimensional (3D) object (for example, as in the right diagram of FIG. 10, the ray 8 for operating a three-dimensional object is operated by the movement operation of the controller 6, and the determination operation for the ray is performed by the button operation of the controller. Alternatively, as illustrated by 3 in the right diagram of FIG. 10, the operation of grabbing the three-dimensional object is performed by the button operation of the controller, and the grabbed three-dimensional object is moved by the movement operation of the controller).

An implementation is conceivable in which an object on which the button operation of the controller is reflected is changed by switching the method of reflecting the operation of the controller on the system without switching the display method, in the above-mentioned manner.

Note that the above description assumes a situation where one controller 6 is used for both the 2D-mouse operation and the 6oF. operation; however, for another configuration where the 6DoF controller 6 separated from the mouse is used, the display mode may be automatically switched, detecting that the 6DoF controller 6 has been lifted from the state where the 6DoF controller 6 is placed, in a similar manner. In this case, the 2D operation and the 6DoF operation may be treated as being mutually exclusive, such that the 2D operation using the mouse operation may be disabled (such that the mouse does not function even when moved) during the operation of the 6DoF controller 6.

In addition, a situation where the mouse is operated with the same hand as that holds the 6DoF controller 6 separated from the mouse is also conceivable. In this case, not performing the above-mentioned disabling processing, the system may detect that a mouse operation has been performed from the output information of the mouse, and the state of reflection of the operation of the 6DoF controller 6 on the system may be switched. Specifically, the ray displayed while the 6DoF controller 6 is operated may be turned off when a mouse operation is performed.

In addition, the above description assumes a situation where a function member, for example, the movement detecting section 43 such as an optical sensor of FIG. 17 is mounted as a member separated from the member for detecting the position and posture of the 6DoF of the controller in order to output the movement information with respect to a plane. On the other hand, the movement information of the controller 6 on a plane may be obtained from the position posture information of the 6DoF function of the controller 6. Therefore, the above-described control of switching the display and function can be performed without separately providing the mouse function member such as the movement detecting section 43. Specifically, for example, an implementation is conceivable in which from the plane information obtained by the camera on the HMD and the location information of the 6DoF of the controller, the state where the controller 6 is located on a plane is detected, and in that case, the control is switched to the 2D operation mode and then the cursor movement of the mouse on the 2D display is implemented using the 6DoF location information, for example.

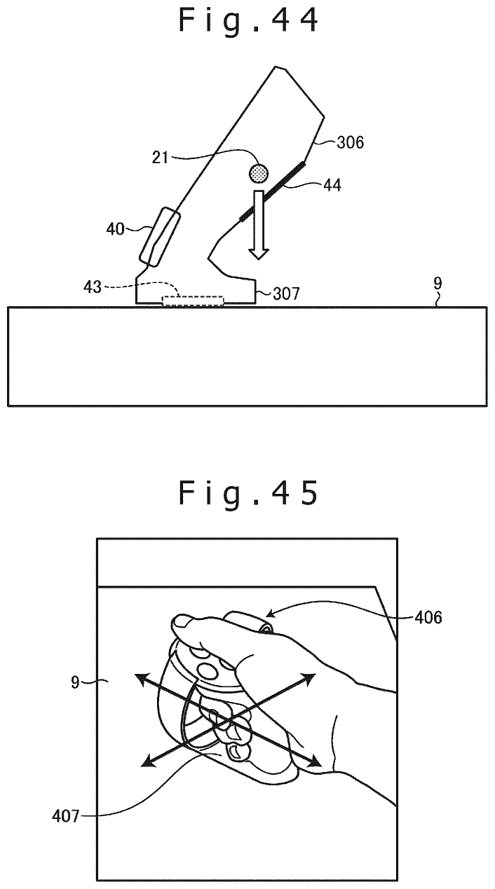

In addition, in such an implementation, when the controller 6 is of a grabbing type, a favorable operation can be achieved by providing a plane portion that allows the controller 6 to stand independently without tipping over when the controller 6 is placed on a plane (regardless of whether there is the movement detecting section 43) as illustrated in FIG. 44 and FIG. 47.

### 6-5. Fifth Feature of Controller 6

The controller 6 according to the embodiment switches the action of the button of the controller 6 between a 2D operation (typical mouse operation) and a 6DoF operation (aerial operation).

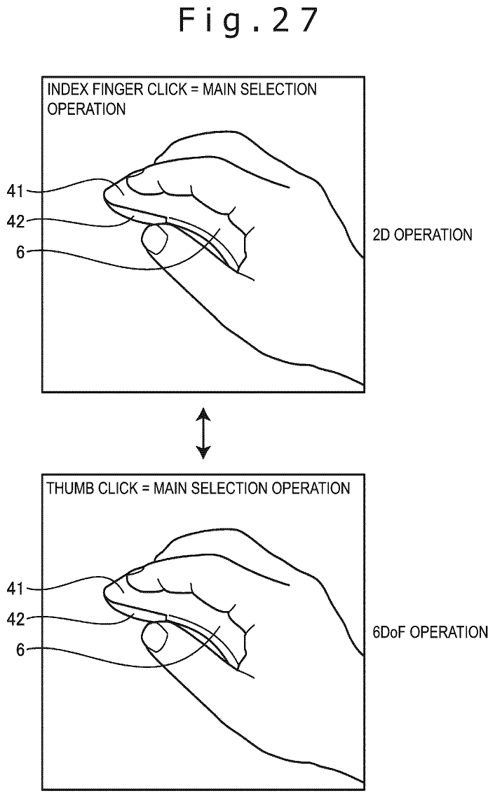

FIG. 27 is a diagram illustrating a first example of switching of the button operation of the controller 6 according to the embodiment between a 2D operation (typical mouse operation) and a 6DoF operation (aerial operation).

As illustrated in FIG. 27, during the 2D operation, the controller 6 is assigned the main selection operation, which is the function of the left button 41 of the controller 6 (corresponding to the left button of a typical mouse). During the 6DoF operation of the controller 6, the thumb button 42 of the controller 6 is assigned the main selection operation, which is the function of the left button.

In the controller 6 according to the embodiment, when it is in the air, the reactive force generated when the thumb button 42 is pushed with the thumb can be received by the ring finger/little finger, and therefore in the 6DoF operation, the thumb button 42 is set to the main selection operation (the left click operation in a typical mouse).

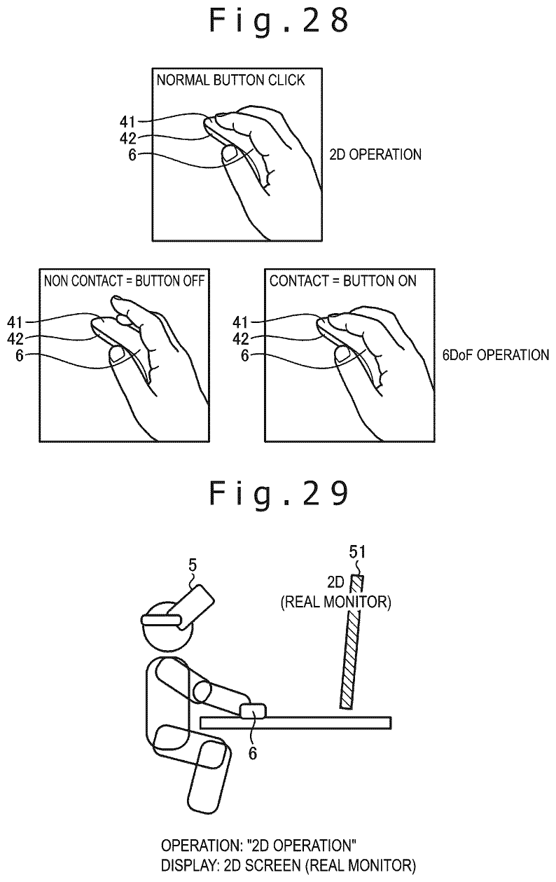

FIG. 28 is a diagram illustrating a second example of switching of the button operation of the controller 6 according to the embodiment between a 2D operation (typical mouse operation) and a 6DoF operation (aerial operation).

As illustrated in FIG. 28, in the 2D operation, left and right clicks of a typical mouse are assigned as the left and right clicks, while in the 6DoF operation, in which it is difficult to operate due to the need for supporting the reactive force with the finger on the opposite side in order to click with no support by the ground, the button is set to be turned ON by a “touch” on a finger resting region (for example, the left button 41) instead of a “click”.

### 7. Switching Between 2D Display/3D Display According to Embodiment

As patterns of the operation of the controller 6 and the display viewed by the user, the following patterns illustrated in FIGS. 29 to 32 are conceivable.

FIG. 29 is a diagram illustrating a first pattern where a real monitor is set as the display screen when the controller 6 according to the embodiment is “2D-operated”. In this first pattern, the user flips up the HMD 5 and views the screen displayed on a real monitor 51.

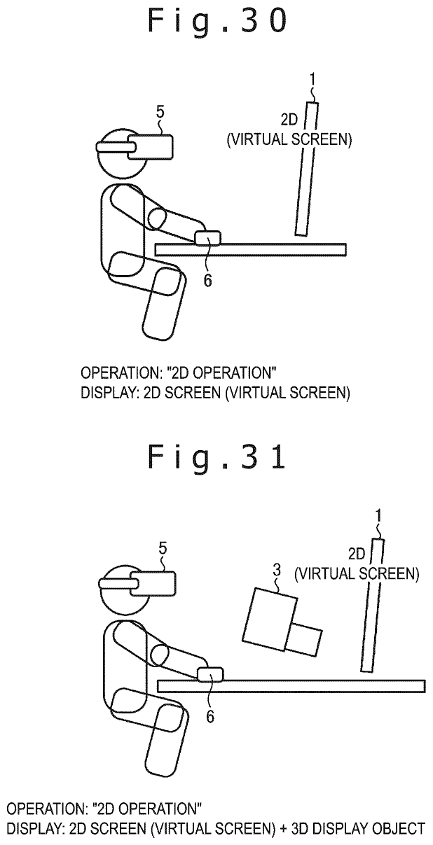

FIG. 30 is a diagram illustrating a second pattern where the virtual screen 1 is set as the display screen when the controller 6 according to the embodiment is “2D-operated”. In this second pattern, the user views the virtual screen 1 displayed on the HMD 5.

FIG. 31 is a diagram illustrating a third pattern where the virtual screen 1 and the object 3 of the 3D display are set as the display screen when the controller 6 according to the embodiment is “2D-operated”. In this third pattern, the user views the virtual screen 1 and the object 3 of the 3D display displayed on the HMD 5.

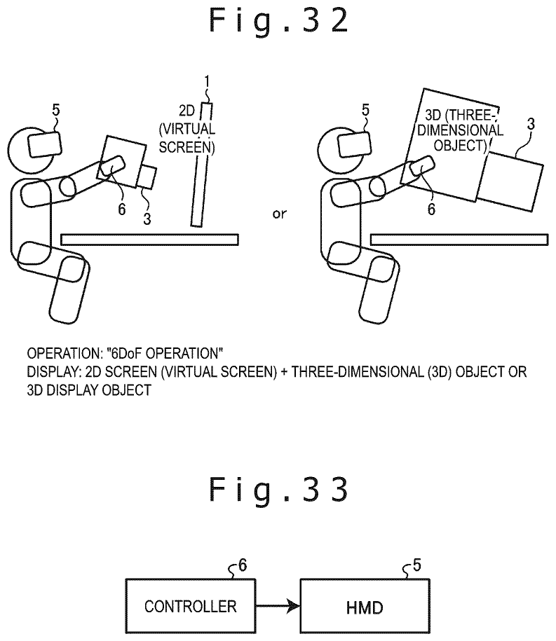

FIG. 32 is a diagram illustrating a fourth pattern where the virtual screen 1 and the object 3 of the 3D display or the object 3 of the 3D display is set as the display screen displayed on the HMD 5 when the controller 6 according to the embodiment is “6DoF-operated”.

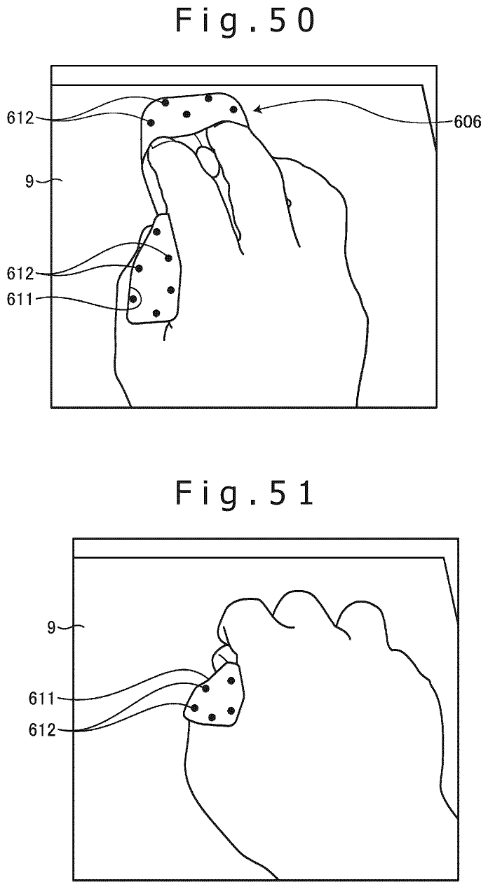

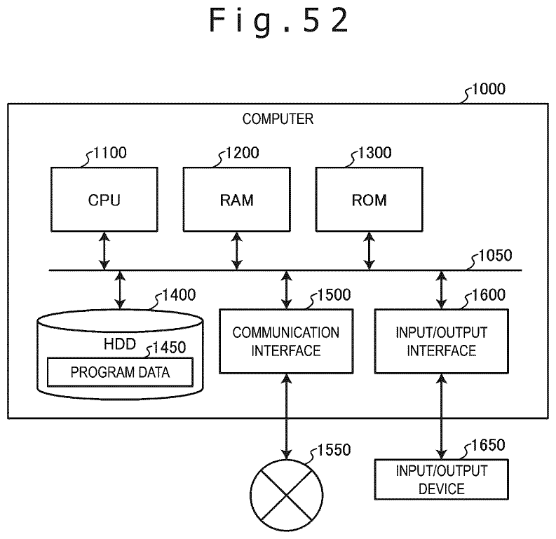

For a display switching method, the display switching from FIG. 30 to FIG. 32, or the display switching from FIG. 31 to FIG. 32 may be automatically performed by detecting an operation of lifting the controller 6 having the 6DoF function according to the embodiment (or lifting a 6DoF controller separated from a mouse) (as described also in “6-4. Fourth feature of controller 6”). In addition, the display switching from FIG. 52 to FIG. 50 and the reverse display switching from FIG. 52 to FIG. 51 may be automatically performed by detecting an operation of putting the controller 6 on a desk.

The display switching from FIG. 29 to FIG. 30, from FIG. 29 to FIG. 31, and from FIG. 29 to FIG. 32 may be automatically performed by detecting a flip-down operation of the HMD 5 having a flip-up structure. In addition, the reverse display switching from FIG. 50 to FIG. 49, from FIG. 51 to FIG. 49, and from FIG. 52 to FIG. 49 may be automatically performed by detecting a flip-up operation.

The display switching from FIG. 29 to FIG. 30, from FIG. 29 to FIG. 31, and from FIG. 29 to FIG. 32 may be performed through an UI operation of a GUI operation in the real monitor 51 (for example, selection and determination of the “VR mode” button). Likewise, the reverse display switching from FIG. 50 to FIG. 49, from FIG. 51 to FIG. 49, and from FIG. 52 to FIG. 49 may be performed through an operation using the controller 6 (or using a typical mouse or a 6DoF mouse) on the GUI displayed on the HMD 5.

The above-mentioned display switching may be performed through voice input by the user. In addition, it may be performed through a button operation on the controller 6, a mouse operation, or a keyboard operation.

For a display method for the virtual screen 1, when the virtual screen 1 is displayed in a VR space, the position, orientation, size, and the like thereof may be matched with those of the real monitor 51. Likewise, the virtual screen 1 may be displayed with the image quality, cursor position, and display content matched with those of the real monitor 51. This makes it possible to reduce an operational load and a cognitive load on the user that are associated with the display switching.

In the VR display state of FIGS. 30, 31, and 32, whether the virtual screen 1 is generated and where the virtual screen 1 is displayed may be determined on the basis of the type and display size of the object 3 of the 3D display and switched. For example, in the case where the size of the display object is large, such as the interior of a vehicle, the 2D monitor screen might be obscured by the object 3 of the 3D display; therefore, in such cases, the virtual screen 1 is not displayed. In addition, for example, in the case where the display area of the object 3 of the 3D display overlaps the virtual screen 1 due to the operation of the user, the ON/OFF of the display and the display mode (such as transparency) of the virtual screen 1 may be switched.

### 8. Functional Block Diagram

### 8-1. Connection Configuration of Controller 6 and HMD 5

FIG. 33 is a diagram illustrating a connection relationship between the HMD 5 and the controller 6 according to the embodiment. In this case, an output signal including a switching signal and the like from the controller 6 is input to the HMD 5. The HMD 5 performs a processing such as switching of the display mode of the display screen in response to the output signal output from the controller 6.

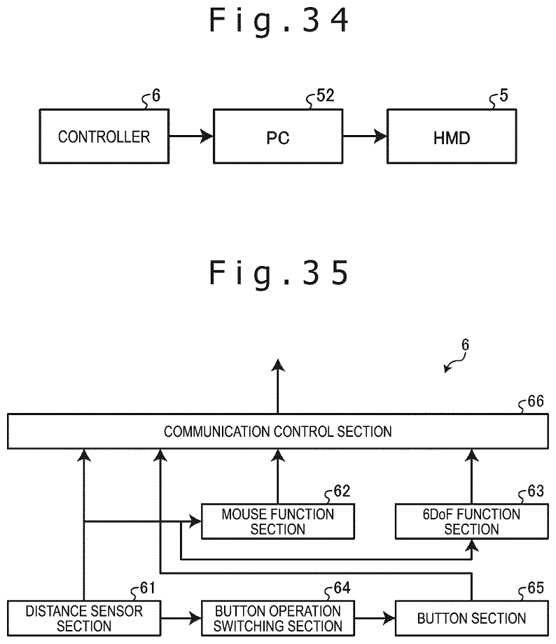

As illustrated in FIG. 33, the controller 6 is connected directly to the HMD 5, but the controller 6 may be connected to the HMD 5 through a personal computer (PC) 52 as illustrated in FIG. 34.

In this case, an output signal including a switching signal and the like from the controller 6 is input to a PC 54. The signal exchanged between the PC 52 and the HMD 5 is dependent on the role of the PC 52 and the role of the HMD 5.

For example, the PC 52 performs a processing such as switching of the display mode of the display screen in response to the output signal output from the controller 6. In addition, the PC 52 performs a processing such as outputting of a video signal for display to the HMD 5, for example.

The embodiment describes a case where the controller 6 and the HMD 5 are directly connected.

### 8-2. Functional Block Diagram of Controller 6 According to Embodiment

FIG. 35 is a functional block diagram of the controller 6 according to the embodiment. As illustrated in FIG. 35, the controller 6 includes a distance sensor section 61, the mouse function section 62, the 6DoF function section 63, a button operator switching section 64, a button section 65, and a communication control section 66.

The distance sensor section 61 measures the distance from the plane 9 on which the controller 6 is placed. In addition, the distance sensor section 61 outputs a switching signal to the communication control section 66 when the measured distance is greater than a threshold distance. The switching signal is a signal for switching a display mode of a two-dimensional image to which the coordinate information output from the mouse function section 62 is applied and a three-dimensional image to which the position posture information output from the 6DoF function section 63 is applied.

The mouse function section 62 outputs the coordinate information on the plane 9 on which the controller 6 is placed to the communication control section 66. The communication control section 66 the mouse function section 62 is off and does not output the coordinate information to the communication control section 66 while receiving the switching signal from the distance sensor section 61, and is on and outputs the coordinate information to the communication control section 66 when not receiving the switching signal.

The 6DoF function section 63 outputs the position posture information of the controller 6 to the communication control section 66. The 6DoF function section 63 is on and outputs the position posture information to the communication control section 66 while receiving a switching signal from the distance sensor section 61, and is off and does not output the position posture information to the communication control section 66 when not receiving the switching signal.

When the switching signal is received from the distance sensor section 61, the button operator switching section 64 switches the function of the action in a two-dimensional image assigned to the button section 65 to the function of the action in a three-dimensional image. When the switching signal is not received, the button operator switching section 64 assigns to the button section 65 the function of the action in a two-dimensional image assigned to the button section 65, whereas when the switching signal is received, the button operator switching section 64 assigns to the button section 65 the function of the action in a three-dimensional image.

In addition, the button operator switching section 64 switches the action for selecting the button section 65. For example, when the switching signal is not received, the 2D operation is performed, and the button section 65 is selected by clicking the button section 65. When the switching signal is received, the 6DoF operation is performed, and the button section 65 is selected by touching the button section 65.

The button section 65 includes a plurality of buttons. The button includes the left button 41 and the right button (not illustrated) of the controller 6, and the thumb button 42 provided on the side surface of the controller 6, for example. When the switching signal is output, that is, when the function of the action in a three-dimensional image is assigned, the button section 65 outputs a signal indicating the selected button to the communication control section 66. When the switching signal is not output, that is, when the function of the action in a two-dimensional image is assigned, the button section 65 outputs a signal indicating the selected button to the communication control section 66.

The communication control section 66 outputs the switching signal output from the distance sensor section 61, the coordinate information output from the mouse function section 62, the position coordinate information output from the 6DoF function section 63, and the signal indicating the selected button output from the button section 65 to the HMD 5, which is an information processing device.

Note that, since the HMD 5 can recognize, with the switching signal, the 2D operation or 6DoF operation of the controller 6, all signals (the coordinate information output from the mouse function section 62, the position coordinate information output from the 6DoF function section 63, and the signal indicating the selected button output from the button section 65) may be output from the controller 6, and selected in the HMD 5.

Note that, as illustrated in FIG. 34, in the case where the controller 6 is connected to the HMD through the PC 52, the communication control section 66 outputs the switching signal and the like to the PC 52.

### 8-3. Functional Block Diagram of HMD 5 According to Embodiment

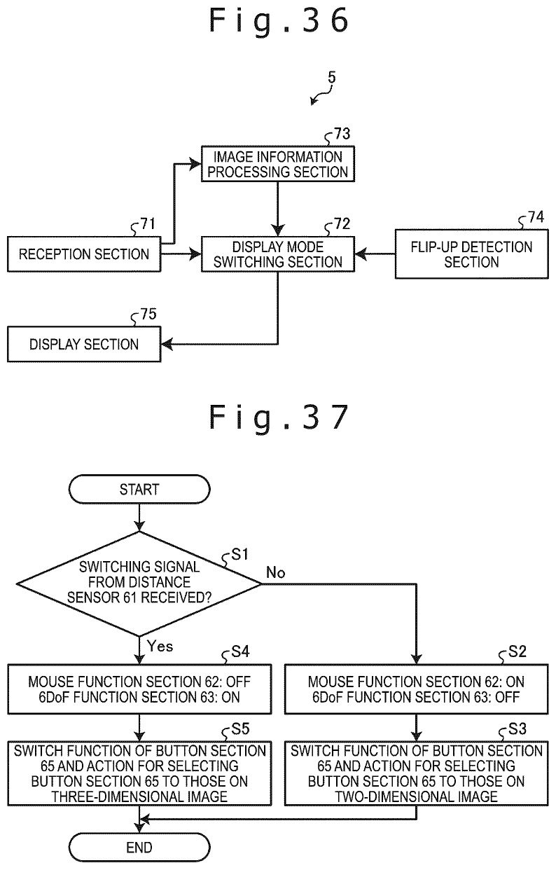

FIG. 36 is a functional block diagram of the HMD 5 according to the embodiment. As illustrated in FIG. 36, the HMD 5 includes a reception section 71, a display mode switching section 72, an image information processing section 73, a flip-up detection section 74, and a display section 75.

The reception section 71 receives an output signal that includes a switching signal, coordinate information, position coordinate information, and a signal indicating the selected button and has been output from the communication control section 66 of the controller 6.

The image information processing section 73 stores a two-dimensional image and a three-dimensional image to be displayed on the display section 75, and outputs the two-dimensional image and/or the three-dimensional image to the display mode switching section 72 in response to the output signal. In addition, the image information processing section 73 performs a processing corresponding to the coordinate information, the position coordinate information, and the signal indicating the selected button of the output signal by the reception section 71. Note that the image information processing section 73 may be provided separately from the HMD 5.

The display mode switching section 72 switches a first display mode of displaying a two-dimensional image to a second display mode of displaying a three-dimensional image in response to the received switching signal. When the switching signal is not received and the 2D operation is performed, the display mode switching section 72 switches the second display mode of displaying a three-dimensional image to the first display mode of displaying a two-dimensional image.

Note that, when the distance data from the plane on which the controller is placed received from the controller 6 is greater than the threshold distance, the HMD 5 switches the first display mode of displaying the two-dimensional image to the second display mode of displaying the three-dimensional image. In addition, when the distance data from the plane on which the controller is placed received from the controller 6 is greater than the threshold distance, the PC 52 may output the switching signal to the HMD 5.

The display mode switching section 72 outputs the two-dimensional image and three-dimensional image output from the image information processing section 73 to the display section 75 in accordance with the display mode. For example, in the case of the first display mode, the display mode switching section 72 outputs the two-dimensional image to the display section 75. In the case of the first display mode, the display mode switching section 72 may output the two-dimensional image and the three-dimensional image to the display section 75. In the case of the second display mode, the display mode switching section 72 outputs the three-dimensional image to the display section 75. In the case of the second display mode, the display mode switching section 72 may output the two-dimensional image and the three-dimensional image to the display section 75.

The flip-up detection section 74 detects flipping up of the HMD 5, and outputs it to the display mode switching section 72. When the flipping up is not detected by the flip-up detection section 74 (in the case of flipping down), the display mode switching section 72 outputs an image according to the display mode.

The display section 75 displays the image output from the display mode switching section 72.

### 9. Description of Actions

### 9-1. Action of Controller 6 According to Embodiment

FIG. 37 is a flowchart for describing actions of the mouse function section 62 and the 6DoF function section 63 in response to the switching signal of the controller 6 according to the embodiment. As shown in FIG. 37, the mouse function section 62 and the 6DoF function section 63 determine whether the switching signal has been received from the distance sensor section 61 (step S1).

When it is determined that the switching signal has not been received (No in step S1), the mouse function section 62 is turned on, and the 6DoF function section 63 is turned off (step S2). As a result, a signal for the 2D operation is output from the mouse function section 62. Next, the button operator switching section 64 switches the function of the button section 65 and action for selecting the button section 65 to those on the two-dimensional image (step S3), and the processing is terminated.

On the other hand, when it is determined in step S1 that the switching signal has been received (Yes in step S1), the mouse function section 62 is turned off, and the 6DoF function section 63 is turned on (step S4). As a result, a signal for the 3D operation is output from the 6DoF function section 63. Next, the button operator switching section 64 switches the function of the button section 65 and action for selecting the button section 65 to those on the three-dimensional image (step S5), and the processing is terminated.

### 9-2. Action of HMD 5 According to Embodiment

### 9-2-1. First Action of HMD 5 According to Embodiment

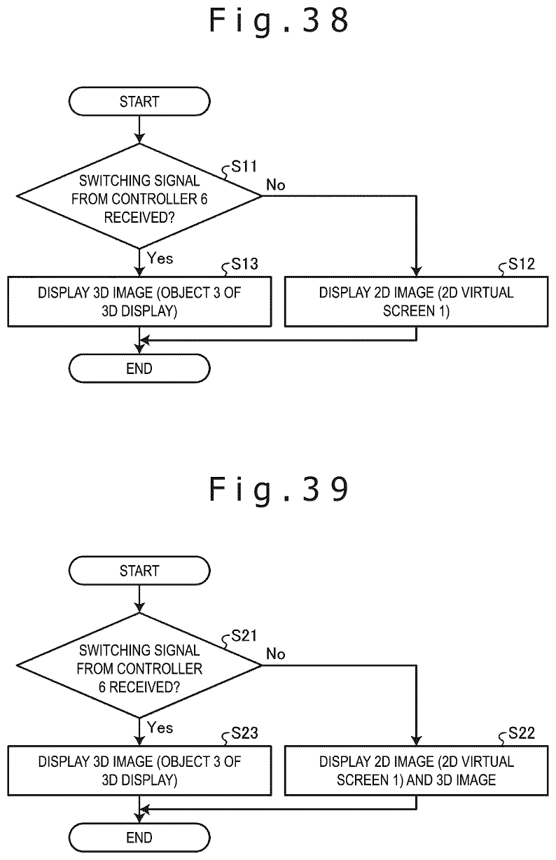

FIG. 38 is a flowchart for describing a first example of an action in response to a switching signal of the HMD 5 according to the embodiment. As shown in FIG. 38, the HMD 5 determines whether a switching signal has been received from the controller 6 (step S11).

When it is determined that the switching signal has not been received from the controller 6 (No in step S11), a 2D image (the virtual screen 1) is displayed (step S12). When the switching signal has been received from the controller 6 (Yes in step S11), a 3D image (the object 3 of the 3D display) is displayed (step S13).

### 9-2-2. Second Action of HMD 5 According to Embodiment

FIG. 39 is a flowchart for describing a second example of an action in response to a switching signal of the HMD 5 according to the embodiment. As shown in FIG. 39, the HMD 5 determines whether a switching signal has been received from the controller 6 (step S21).

When it is determined that the switching signal has not been received from the controller 6 (No in step S21), a 2D image (the virtual screen 1) and a 3D image are displayed (step S22). When the switching signal is received from the controller 6 (Yes in step S21), a 3D image (the object 3 of the 3D display) is displayed (step S23).

### 9-2-3. Third Action of HMD 5 According to Embodiment

FIG. 40 is a flowchart for describing a third example of an action in response to a switching signal of the HMD 5 according to the embodiment. As shown in FIG. 40, the HMD 5 determines whether a switching signal has been received from the controller 6 (step S31).

When it is determined that the switching signal has not been received from the controller 6 (No in step 31), a 2D image (the virtual screen 1) is displayed (step S32). When the switching signal has been received from the controller 6 (Yes in step 31), a 2D image (the virtual screen 1) and a 3D image (the object 3 of the 3D display) are displayed (step S33).

### 9-2-4. Action for Flip-Down Operation of HMD 5 According to Embodiment

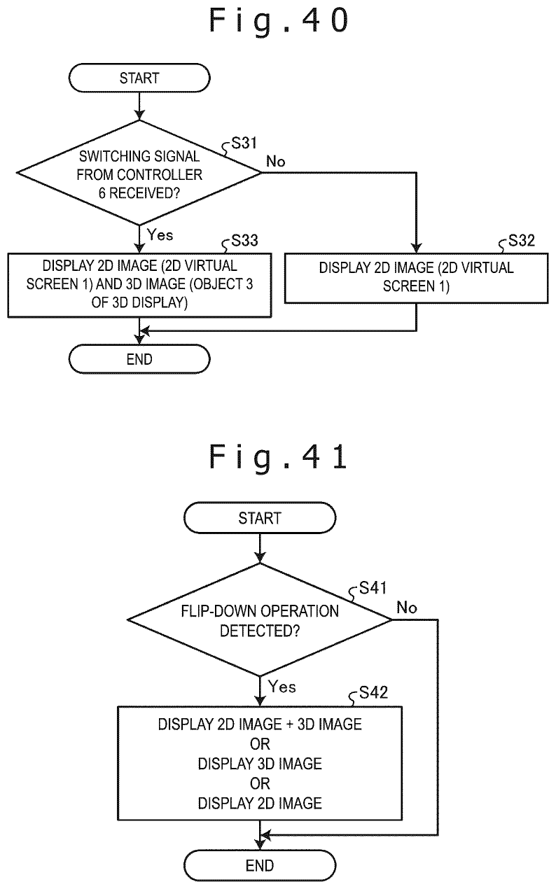

FIG. 41 is a flowchart for describing a fourth example of an action in response to a flip-down operation of the HMD 5 according to the embodiment. As shown in FIG. 41, the HMD 5 determines whether a flip-down operation has been performed (step S41).

When a flip-down operation has not been performed but a flip-up operation has been performed in step S41 (No in step S41), the processing is not performed. On the other hand, when a flip-down operation has been performed in step S41 (Yes in step S41), a 2D image and a 3D image, a 3D image, or a 2D image is displayed on the HMD 5 (step S42).

### 10. Variation of embodiment

### 10-1. Shape of Controller 6

### 10-1-1. Pen-Type Mouse

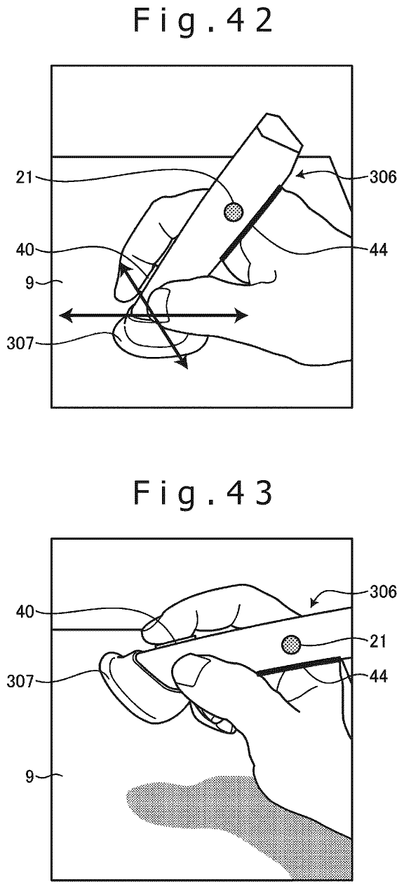

FIG. 42 is a diagram illustrating a state where a controller 306 with a pen-type mouse shape according to a variation of the shape of the controller 6 according to the embodiment is in contact with a surface. FIG. 43 is a diagram illustrating a state where the controller 306 with the pen-type mouse shape according to the variation of the shape of the controller 6 according to the embodiment is lifted. FIG. 44 is a diagram illustrating a configuration of the controller 306 according to the variation of the embodiment.

As illustrated in FIGS. 42 and 43, a grip portion of the controller 306 with a pen-type mouse shape has a pen-like shape, and a plane portion 307 is provided at its tip end. The plane portion 307 has a shape that can stably make contact with the contact surface.

As illustrated in FIG. 44, the plane portion 307 includes the movement detecting section 43 that detects two-dimensional relative movement distance with respect to the contact surface (not illustrated).

In addition, in the grip portion of the controller 306, an operation button 40 is disposed at the position where the index finger and the thumb touch, and the button operation is performed with the index finger and the thumb. In the state where the controller 306 is in contact with a surface, the mouse operation is performed mainly with the index finger, the thumb, and the middle finger. In the state where the controller 306 is lifted, the button operation is performed with the index finger and the thumb, and the controller 306 with a pen-type mouse shape is held with the index finger, the thumb, the middle finger and the base portion of the index finger.

The controller 306 with a pen-type mouse shape satisfies the requirement of a mouse described in “2. Definition of mouse”. The plane portion 307 moves integrally with the grip portion during the 2D operation, but may remain on a desk like a pen stand during the 6DoF operation.

### 10-1-1-1. Third Feature of Controller 306 According to Embodiment

The controller 306 according to the variation of the embodiment has a structure for preventing the movement of the controller 306 in the longitudinal direction in the palm due to the influence of gravity when a 6DoF operation is performed with the controller 306.

As illustrated in FIGS. 43 and 44, the controller 306 includes, at the side surface thereof, a side surface portion 44 that makes contact with the thumb and the base portion of the index finger of the hand when the controller 306 is lifted for a 3D operation.

Accordingly, for the controller 306, when the controller 306 is lifted for the 3D operation, the side surface portion 44 mainly makes contact with the thumb and the base portion of the index finger of the hand, thereby generating a force that resists a falling force and a turning force resulting from the loss of a reactive force from the plane by the lifting action, and thus maintaining the posture of the mouse relative to the hand without requiring the user to increase the gripping force or change the posture of the hand.

### 10-1-2. Grip-Type Mouse

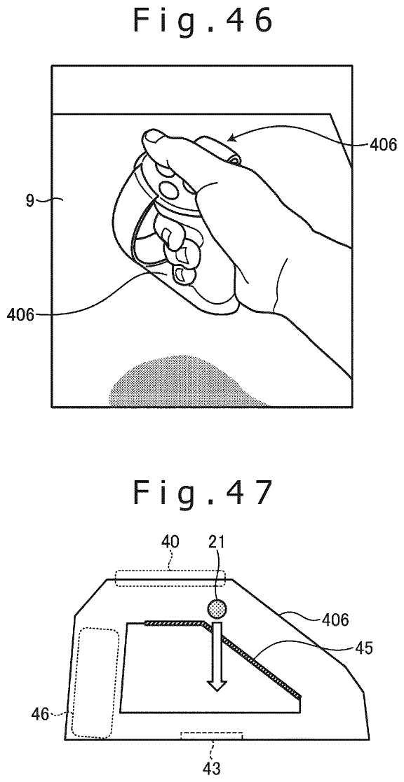

FIG. 45 is a diagram illustrating a state where a controller 406 with a grip-type mouse shape according to a variation of the shape of the controller 6 according to the embodiment is in contact with a surface. FIG. 46 is a diagram illustrating a state where the controller 406 with the grip-type mouse shape according to the variation of the shape of the controller 6 according to the embodiment is lifted. FIG. 47 is a diagram illustrating a configuration of the controller 406 according to a variation of the embodiment.

As illustrated in FIGS. 45 and 46, the controller 406 with the grip-type mouse shape includes, at its lower portion, a plane portion 407 serving as a contact surface. The plane portion 407 has a shape that can stably make contact with the contact surface. The plane portion 407 includes the movement detecting section 43 (not illustrated) that detects two-dimensional relative movement distance with respect to the contact surface.

In addition, as illustrated in FIG. 47, in the controller 406, the operation button 40 is disposed at the position where the index finger and the thumb touch, and a button operation is performed with the index finger and the thumb. In the state where the controller 406 is in contact with a surface, a mouse operation is performed mainly with the wrist and the entire arm. In the state where the controller 406 is lifted, the button operation is performed with the index finger and the thumb, and the controller 406 is held with the entire palm.

A 6DoF position detecting section 46 such as an optical marker is provided in the interior of the controller 406. The controller 406 includes a hollow portion, and the user's middle finger, ring finger, and little finger are inserted into the hollow portion.

The controller 406 with a pen-type mouse shape satisfies the requirement of a mouse described in “2. Definition of mouse”. In a 2D operation, the plane portion 407 moves integrally with the grip portion on the plane 9.

### 10-1-2-1. Third Feature of Controller 406 According to Embodiment

The controller 406 according to the variation of the embodiment has a structure for preventing the movement of the controller 406 in the longitudinal direction in the palm due to the influence of gravity when a 6DoF operation is performed with the controller 406.

As illustrated in FIGS. 45 to 47, the controller 406 includes an inner wall portion 45 with which the middle finger, the ring finger, and the little finger make contact when the controller 406 is lifted for a 3D operation.

Accordingly, for the controller 406, when the controller 406 is lifted for the 3D operation, the inner wall portion 45 mainly makes contact with the middle finger, the ring finger, and the little finger of the hand, thereby generating a force that resists a falling force and a turning force resulting from the loss of a reactive force from the plane by the lifting action, and thus maintaining the posture of the mouse relative to the hand without requiring the user to increase the gripping force or change the posture of the hand.

Note that, as a 6DoF control means, an operation corresponding to the button operation on the controller 406 may be performed through the keyboard operation by the left hand, utilizing right-hand hand tracking using the camera of the HMD 5, for example.

### 10-2. Shape of Controller 6 (in Case of Luminous Point Tracking Method)

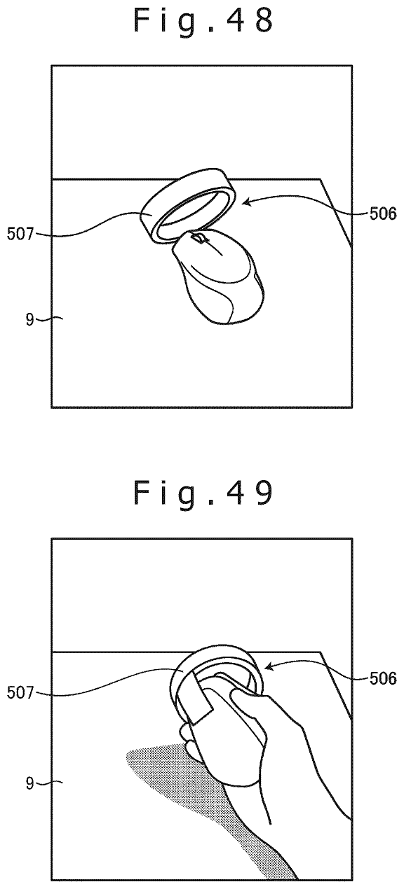

FIG. 48 is a diagram illustrating a state where a controller 506 with a mouse shape using a luminous point tracking method according to a variation of the shape of the controller 6 according to the embodiment is in contact with a surface. FIG. 49 is a diagram illustrating a state where the controller 506 is lifted.

As illustrated in FIGS. 48 and 49, the controller 506 includes a ring 507 at its tip end. A light-emitting diode (LED) that serves as a luminous point is disposed on the inside of the ring 507.

FIG. 50 is a diagram illustrating a state where a controller 606 with a mouse shape using a luminous point tracking method according to a variation of the shape of the controller 6 according to the embodiment is in contact with a surface. FIG. 51 is a diagram illustrating a state where the controller 606 is covered with a hand in a different manner.

As illustrated in FIGS. 50 and 51, the controller 606 is provided with a protruding portion 611 at the side surface between the portions where the thumb and the index finger come into contact. A plurality of luminous points 612 (for example, LEDs) are disposed in the protruding portion 611. In addition, the plurality of luminous points 612 are disposed also in the portions of left and right buttons on the top surface of the controller 606 with the mouse shape.

As such, there is a risk in the controller 606 that the LEDs serving as the luminous points 612 are obscured by the hand, but in the controller 606, there is no risk that the luminous points 612 are obscured by the hand as illustrated in FIG. 52. Therefore, the luminous points can be robustly detected.

### 10-3. Example of Switching Between 2D Operation/6 DoF Operation With Other Controller Structure

In the embodiment-described above, the case where both a 2D operation/a 6DoF operation are implemented by using the controller 6 or the like is described.

For the switching between the 2D operation/the 6DoF operation, a wearable controller (ring) that can coexist with a mouse operation may be provided, and when detecting the lifting of the hand by the ring or hand tracking, switching between the 2D operation mode and the 6DoF operation mode may be performed.

In addition, the right hand is used for free-hand tracking, and the left hand is used for a button operation. Switching between the 2D operation mode and the 6DoF operation mode may be performed, detecting the lifting of the hand by hand tracking.

### 11. Hardware Configuration

FIG. 52 is a hardware configuration diagram illustrating an example of a computer that implements an information processing device of the HMD 5 according to the embodiment.

A computer that implements the above-described information processing device according to each embodiment is implemented with a computer 1000 with a configuration illustrated in FIG. 52. FIG. 52 is a hardware configuration diagram illustrating an example of the computer 1000 that implements a function of a computing device. The computer 1000 includes a CPU 1100, a RAM 1200, a read only memory (ROM) 1300, a hard disk drive (HDD) 1400, a communication interface 1500, and an input/output interface 1600. Sections of the computer 1000 are connected via a bus 1050.

The CPU 1100 operates in accordance with a program stored in the ROM 1300 or the HDD 1400, and controls each section. For example, the CPU 1100 loads programs stored in the ROM 1300 or the HDD 1400 into the RAM 1200, and executes processings corresponding to various programs.

The ROM 1300 stores boot programs such as a basic input output system (BIOS) to be executed by the CPU 1100 at the startup of the computer 1000, programs dependent on the hardware of the computer 1000, and the like.

The HDD 1400 is a computer-readable recording medium that non-transitorily stores programs to be executed by the CPU 1100, data to be used by such programs, and the like. Specifically, the HDD 1400 is a recording medium that stores an application program according to the present disclosure, which is an example of program data 1450.

The communication interface 1500 is an interface for connecting the computer 1000 to an external network 1550 (e.g., the Internet). For example, the CPU 1100 receives data from other devices or transmits data generated by the CPU 1100 to other devices, via the communication interface 1500.

The input/output interface 1600 is an interface for connecting an input/output device 1650 and the computer 1000. For example, the CPU 1100 receives data from input devices such as a keyboard and a mouse via the input/output interface 1600. The CPU 1100 also transmits data to output devices such as a display, a speaker, and a printer via the input/output interface 1600. In addition, the input/output interface 1600 may function as a media interface that reads a program or the like recorded in a predetermined recording medium. The medium refers to an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 functions as a computing device of the HMD 5, the CPU 1100 of the computer 1000 implements the processings according to the embodiment by executing a program loaded into the RAM 1200. The CPU 1100 reads and executes the program data 1450 from the HDD 1400; alternatively, the CPU 1100 may obtain such programs from another device via the external network 1550.

While the preferred embodiments of the present disclosure have been described above in detail with reference to the accompanying drawings, the technical scope of the present disclosure is not limited to such examples. It will be apparent that a person having ordinary knowledge in the technical field of the present disclosure can conceive various modifications and alterations within the scope of the technical ideas described in the claims, and such modifications and alterations are naturally understood to fall within the technical scope of the present disclosure.

Further, the effects described in this specification are merely illustrative or exemplary and are not limited. That is, the technique according to the present disclosure can produce other effects that are apparent to those skilled in the art from the description of this specification, either in addition to or in place of the above-described effects.

Note that the present technique may also adopt the following configurations.
(1)
A controller including:
a mouse function section configured to output coordinate information of a plane;
a 6DoF function section configured to output position posture information; and
a switching signal output section configured to output a switching signal for switching between a display mode of a two-dimensional image to which the coordinate information output from the mouse function section is applied and a display mode of a three-dimensional image to which the position posture information output from the 6DoF function section is applied.
(2)
The controller according to (1), in which
the switching signal output section
includes a distance sensor configured to measure a distance from a plane on which the controller is placed, and
outputs the switching signal when the distance measured with the distance sensor is greater than a threshold distance.
(3)
The controller according to (1) or (2), in which
when the switching signal is not output, the mouse function section outputs the coordinate information and the 6DoF function section does not output the position posture information, and
when the switching signal is output, the mouse function section does not output the coordinate information and the 6DoF function section outputs the position posture information.
(4)
The controller according to (1) to (3), further including:
a button section assigned a function of an action on the two-dimensional image or a function of an action on the three-dimensional image; and
a button operation switching section configured to switch the function of the action on the two-dimensional image assigned to the button section to the function of the action on the three-dimensional image, when the switching signal is received.
(5)
The controller according to (4), in which the button operation switching section switches an action for selecting the button section.
(6)
The controller according to (1) to (5), in which
the controller has a first side surface, and a second side surface on an opposite side of the first side surface, and
the first side surface includes
a third side surface, and
a fourth side surface formed at an upper portion of the third side surface and on an outer side, relative to the third side surface, of the controller in a front view of the controller.
(7)
The controller according to (6), in which
the second side surface includes
a fifth side surface, and
a sixth side surface formed at an upper portion of the fifth side surface and on the outer side, relative to the fifth side surface, of the controller in the front view of the controller.
(8)
The controller according to (1) to (7), in which
the controller has a first side surface, and a second side surface on an opposite side of the first side surface,
the first side surface includes
a third side surface, and
a fourth side surface formed at an upper portion of the third side surface and on an outer side, relative to the third side surface, of the controller in the front view of the controller,
the second side surface includes
a fifth side surface, and
a sixth side surface formed at an upper portion of the fifth side surface and on the outer side, relative to the fifth side surface, of the controller in the front view of the controller, and
a gravity center of the controller is located between the fourth side surface and the sixth side surface.
(9)
The controller according to (1) to (8), in which the controller has a chevron shape.
(10)
The controller according to (9), in which a gravity center of the controller is located at a center portion of an interior of the controller.
(11)
An information processing device including a display mode switching section configured to switch a first display mode of displaying a two-dimensional image to a second display mode of displaying a three-dimensional image, when a switching signal for switching a display mode is received or when a controller has a distance from a plane on which the controller is placed is greater than a threshold distance.
(12)
The information processing device according to (11), including a display section configured to display the two-dimensional image and the three-dimensional image.
(13)
The information processing device according to (11) or (12), in which in the second display mode, the two-dimensional image is displayed.
(14)
The information processing device according to (13), in which in the first display mode, the three-dimensional image is displayed.
(15)
An information processing method including:
switching a first display mode of displaying the two-dimensional image to a second display mode of displaying the three-dimensional image, when a switching signal for switching a display mode is received or when data, received from a controller, of a distance from a plane on which the controller is placed is greater than a threshold distance.
(16)
An information processing method including:
calculating a distance between a controller and a plane on which the controller is placed; and
switching a first display mode of displaying a two-dimensional image to a second display mode of displaying a three-dimensional image, when the distance calculated is greater than a threshold distance.

### REFERENCE SIGNS LIST

1 Virtual screen
2 2D display object
3 3D display object
5 HMD
6, 106, 206, 306, 406, 506, 606 Controller
7 Line
8 Ray
9 Plane
12 First side surface
13 Second side surface
14 Third side surface
15 Fourth side surface
16 Fifth side surface
17 Sixth side surface
21 Gravity center
25, 26, 27 Inner portion
28 Upper portion
31 Distance sensor
40 Operation button
41 Left button
42 Thumb button
43 Movement detecting section
44 Side surface portion
45 Inner wall portion
46 6DoF position detecting section
51 Real monitor
52 PC
61 Distance sensor section
62 Mouse function section
63 6DoF function section
64 Button operator switching section
65 Button section
66 Communication control section
107 Ring
307, 407 Plane portion
611 Protruding portion
612 Luminous point

1. A controller comprising:
a mouse function section configured to output coordinate information of a plane;
a 6DoF function section configured to output position posture information; and
a switching signal output section configured to output a switching signal for switching between a display mode of a two-dimensional image to which the coordinate information output from the mouse function section is applied and a display mode of a three-dimensional image to which the position posture information output from the 6DoF function section is applied.

2. The controller according to claim 1, wherein
the switching signal output section
includes a distance sensor configured to measure a distance from a plane on which the controller is placed, and
outputs the switching signal when the distance measured with the distance sensor is greater than a threshold distance.

3. The controller according to claim 1, wherein
when the switching signal is not output, the mouse function section outputs the coordinate information and the 6DoF function section does not output the position posture information, and
when the switching signal is output, the mouse function section does not output the coordinate information and the 6DoF function section outputs the position posture information.

4. The controller according to claim 1, further comprising:
a button section assigned a function of an action on the two-dimensional image or a function of an action on the three-dimensional image; and
a button operation switching section configured to switch the function of the action on the two-dimensional image assigned to the button section to the function of the action on the three-dimensional image, when the switching signal is received.

5. The controller according to claim 4, wherein the button operation switching section switches an action for selecting the button section.

6. The controller according to claim 1, wherein
the controller has a first side surface, and a second side surface on an opposite side of the first side surface, and
the first side surface includes
a third side surface, and
a fourth side surface formed at an upper portion of the third side surface and on an outer side, relative to the third side surface, of the controller in a front view of the controller.

7. The controller according to claim 6, wherein
the second side surface includes
a fifth side surface, and
a sixth side surface formed at an upper portion of the fifth side surface and on the outer side, relative to the fifth side surface, of the controller in the front view of the controller.

8. The controller according to claim 1, wherein
the controller has a first side surface, and a second side surface on an opposite side of the first side surface,
the first side surface includes
a third side surface, and
a fourth side surface formed at an upper portion of the third side surface and on an outer side, relative to the third side surface, of the controller in a front view of the controller,
the second side surface includes
a fifth side surface, and
a sixth side surface formed at an upper portion of the fifth side surface and on the outer side, relative to the fifth side surface, of the controller in the front view of the controller, and
a gravity center of the controller is located between the fourth side surface and the sixth side surface.

9. The controller according to claim 1, wherein the controller has a chevron shape.

10. The controller according to claim 9, wherein a gravity center of the controller is located at a center portion of an interior of the controller.

11. An information processing device comprising:
a display mode switching section configured to switch a first display mode of displaying a two-dimensional image to a second display mode of displaying a three-dimensional image, when a switching signal for switching a display mode is received or when a controller has a distance from a plane on which the controller is placed is greater than a threshold distance.

12. The information processing device according to claim 11, further comprising a display section configured to display the two-dimensional image and the three-dimensional image.

13. The information processing device according to claim 11, wherein in the second display mode, the two-dimensional image is displayed.

14. The information processing device according to claim 13, wherein in the first display mode, the three-dimensional image is displayed.

15. An information processing method comprising:
receiving data of a distance of a controller from a plane on which the controller is placed; and
switching a first display mode of displaying a two-dimensional image to a second display mode of displaying a three-dimensional image, when the received data of the distance is greater than a threshold distance.

16. An information processing method comprising:
calculating a distance between a controller and a plane on which the controller is placed; and
switching a first display mode of displaying a two-dimensional image to a second display mode of displaying a three-dimensional image, when the distance calculated is greater than a threshold distance.
